(19) United States
(12) Patent Application Publication
(10) Pub. No.: US 2016/0028445 A1
(43) Pub. Date: Jan. 28, 2016

(54) MITIGATING OVER-COUPLING IN CLOSE PROXIMITY NFC DEVICES

(71) Applicant: QUALCOMM Incorporated, San Diego, CA (US)

(72) Inventors: Mahbod MOFIDI, San Diego, CA (US); Vincent So, San Diego, CA (US); Kritarth Yudhish, San Diego, CA (US); Sumanth Keragodu Surya Prakash, San Diego, CA (US)

(21) Appl. No.: 14/626,106

(22) Filed: Feb. 19, 2015

Related U.S. Application Data
(60) Provisional application No. 62/029,956, filed on Jul. 28, 2014.

(51) Int. Cl. H04B 5/00

(52) U.S. Cl. CPC H04B 5/0081

(57) ABSTRACT

Aspects disclosed herein relate to mitigating an antenna over-coupling condition in near field communication (NFC) devices. A transmission signal for a transmitted carrier is generated at a transmit circuit of an initiator NFC device, and a received carrier is received at a receive circuit of the initiator NFC device. The initiator NFC device can detect an antenna over-coupling condition related to antenna coupling with a remote NFC device based at least in part on the transmission signal and the received carrier. Where the condition is detected, at least one of a transmit circuit parameter for the transmit circuit or a receive circuit parameter of the receive circuit is modified to reduce the antenna over-coupling condition

### CLAIM OF PRIORITY UNDER 35 U.S.C. §119

The present application for patent claims priority to Provisional Application No. 62/029,956 entitled “MITIGATING OVER-COUPLING IN CLOSE PROXIMITY NFC DEVICES” filed Jul. 28, 2014, which is assigned to the assignee hereof and hereby expressly incorporated by reference herein.

### BACKGROUND

Advances in technology have resulted in smaller and more powerful personal computing devices. For example, there currently exist a variety of portable personal computing devices, including wireless computing devices, such as portable wireless telephones, personal digital assistants (PDAs) and paging devices that are each small, lightweight, and can be easily carried by users. More specifically, the portable wireless telephones, for example, further include cellular telephones that communicate voice and data packets over wireless networks. Many such cellular telephones are manufactured with ever increasing computing capabilities, and as such, are becoming tantamount to small personal computers and hand-held PDAs. Further, such devices are enabling communications using a variety of frequencies and applicable coverage areas, such as cellular communications, wireless local area network (WLAN) communications, near field communications (NFC), etc.

In a peer-to-peer configuration with NFC devices having similar antenna shape and size, antennas of the devices can become over-coupled when the devices are within a threshold proximity, such that corresponding matching networks may become detuned. This causes disruption and/or other undesirable effects in communications between the devices.

Thus, improved apparatuses and methods for detecting and/or mitigating such conditions in NFC device communications may be desired.

### SUMMARY

The following presents a summary of one or more aspects to provide a basic understanding of such aspects. This summary is not an extensive overview of all contemplated aspects, and is not intended to identify key or critical elements of all aspects nor delineate the scope of any or all aspects. Its purpose is to present some concepts of one or more aspects form as a prelude to the more detailed description presented later.

According to an example, a method of mitigating an antenna over-coupling condition in a near field communication (NFC) device is described. The method can include generating a transmission signal for a transmitted carrier at a transmit circuit of an initiator NFC device, receiving a received carrier at a receive circuit of the initiator NFC device. The method can further include detecting, at the initiator NFC device, the antenna over-coupling condition related to antenna coupling with a remote NFC device based on at least one of the transmission signal or the received carrier, and modifying at least one of a transmit circuit parameter for the transmit circuit or a receive circuit parameter for the receive circuit to mitigate the antenna over-coupling condition.

According to another example, an apparatus for mitigating an antenna over-coupling condition in a NFC device is described. The apparatus includes a transmitter configured to generate a transmission signal for a transmitted carrier at a transmit circuit of an initiator NFC device, a receiver configured to receive a received carrier at a receive circuit of the initiator NFC device, an over-coupling detecting component configured to detect, at the initiator NFC device, the antenna over-coupling condition related to antenna coupling with a remote NFC device based on at least one of the transmission signal or the received carrier, and a Tx/Rx parameter component configured to modify at least one of a transmit circuit parameter for the transmit circuit or a receive circuit parameter for the receive circuit to mitigate the antenna over-coupling condition.

In yet another example, an apparatus for mitigating an antenna over-coupling condition in a NFC device is described. The apparatus includes means for generating a transmission signal for a transmitted carrier at a transmit circuit of an initiator NFC device, means for receiving a received carrier at a receive circuit of the initiator NFC device, means for detecting, at the initiator NFC device, the antenna over-coupling condition related to antenna coupling with a remote NFC device based on at least one of the transmission signal or the received carrier, and means for modifying at least one of a transmit circuit parameter for the transmit circuit or a receive circuit parameter for the receive circuit to mitigate the antenna over-coupling condition.

Still in a further example, a computer-readable medium storing computer executable code for mitigating an antenna over-coupling condition in a NFC device is described. The computer-readable medium includes code for generating a transmission signal for a transmitted carrier at a transmit circuit of an initiator NFC device, code for receiving a received carrier at a receive circuit of the initiator NFC device, code for detecting, at the initiator NFC device, the antenna over-coupling condition related to antenna coupling with a remote NFC device based on at least one of the transmission signal or the received carrier, and code for modifying at least one of a transmit circuit parameter for the transmit circuit or a receive circuit parameter for the receive circuit to mitigate the antenna over-coupling condition.

To accomplish the foregoing and related ends, the one or more aspects comprise features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram of a wireless communication system according to an aspect.

FIG. 2 is a schematic diagram of a wireless communication system, according to an aspect.

FIG. 3 is a block diagram of a near field communication (NFC) environment, according to an aspect;

FIG. 4 is a flowchart describing an example for detecting an mitigating an antenna over-coupling condition according to an aspect;

FIG. 5 is a block diagram of another NFC environment, according to an aspect; and

FIG. 6 is a functional block diagram example architecture of a communications device, according to an aspect.

### DETAILED DESCRIPTION

Various aspects are now described with reference to the drawings. In the following description, for purposes of explanation, numerous specific details are set forth to provide a thorough understanding of one or more aspects. It should be understood, however, that such aspect(s) may be practiced without these specific details.

Generally, a near field communication (NFC) device or related components can detect an over-coupling condition with one or more other NFC device antennas, and/or can mitigate the over-coupling condition at least in part by modifying one or more transmit parameters of a transmit circuit or one or more receive parameters of a receive circuit. As used herein, the term “over-coupling condition” may refer to a condition where an antenna and/or matching circuit (also referred to herein as “matching network”) of another NFC device couple with the antenna and/or matching circuit of the NFC device, thereby increasing the load on the antenna and matching circuit of the NFC device by an amount that detunes or otherwise changes the resonant frequency to a non-optimal frequency. As such, it should be noted that the “over-coupling condition” may also be referred to as an “over-loading condition.” For instance, such an over-coupling condition may occur when an antenna of a NFC device has a same or substantially similar configuration (e.g., size, shape, etc.) as the antenna of another NFC device within a threshold proximity.

In an aspect, for example, a NFC device can transmit a signal and receive a carrier related to a responsive transmitted signal from a coupled NFC device. The responsive signal may be modified by the load of the antenna and matching circuit of the coupled NFC device. The NFC device may detect the antenna over-coupling condition with the coupled NFC device based on characteristics of the received carrier (e.g., as related to an unloaded version of the transmitted signal). Where the NFC device detects the over-coupling condition, the NFC device can mitigate the over-coupling condition by modifying one or more transmit parameters and/or one or more receive parameters. For example, such transmit parameters may include one or more of an initiator mode resonance, a transmit power, a transmit carrier phase, a transmit power supply voltage, a transmit de-Qing factor (e.g., a Quality factor), etc., and such receive parameters may include a receive acquisition threshold, a receiver gain, a receiver local oscillator (LO) phase, etc. For example, by adjusting one or more transmit parameters, the NFC device may help to alleviate the over-coupling condition with the coupled NFC device by increasing the magnetic field strength to allow the coupled NFC device to more easily modulate the magnetic field. Further, for example, by adjusting one or more receive parameters, the NFC device may achieve better receive performance in such an over-coupling condition. Thus, the present aspects may mitigate an antenna over-coupling condition between two coupled NFC devices.

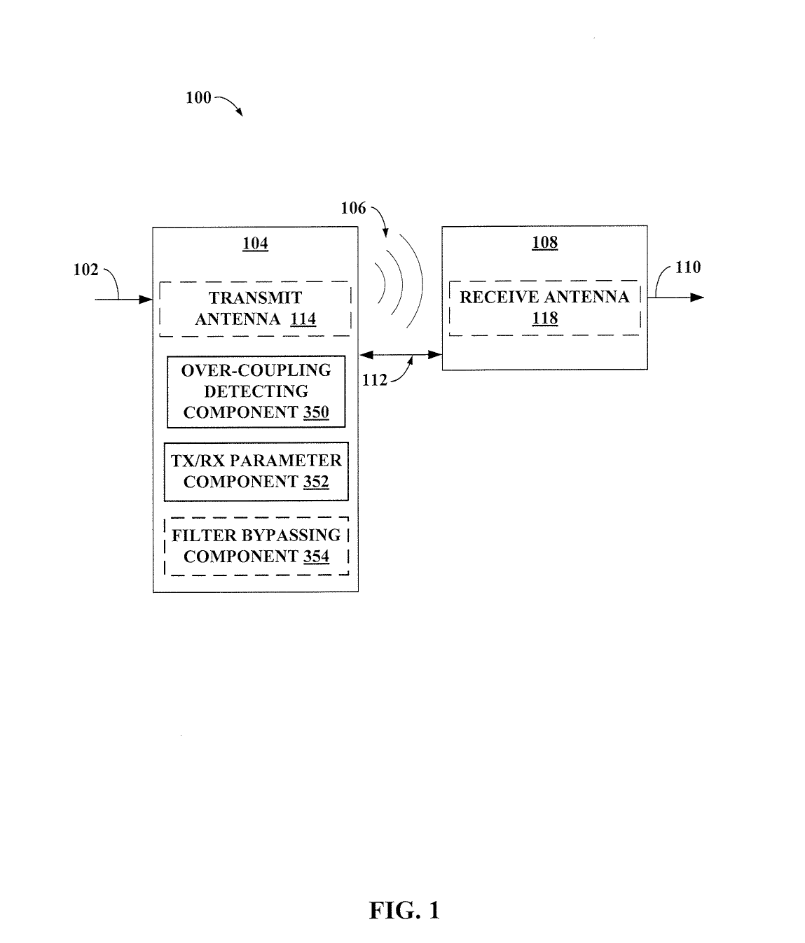

FIG. 1 illustrates a wireless transmission or charging system 100, in accordance with various aspects described herein. Input power 102 is provided to a transmitting entity 104 for generating a radiated inductive field 106 for providing energy transfer. A receiving entity 108 couples to the radiated inductive field 106 and generates an output power 110 for storage or consumption by a device (not shown) coupled to the output power 110. Both the transmitting entity 104 and the receiving entity 108 are separated by a distance 112, which is also referred to herein as an operating volume (OV). In one example, transmitting entity 104 and receiving entity 108 are configured according to a mutual resonant relationship and when the resonant frequency of receiving entity 108 and the resonant frequency of transmitting entity 104 are within a threshold OV, transmission losses between the transmitting entity 104 and the receiving entity 108 are minimal (e.g., when the receiving entity 108 is located in the “near-field” of the radiated inductive field 106).

Transmitting entity 104 further includes a transmit antenna 114 for transmitting energy and signals. A receiving entity 108 includes a receive antenna 118 for receiving signal and energy if needed. The transmit antenna 114 and receive antenna 118 can be sized according to applications and devices associated therewith. As stated, an efficient energy transfer can occur by coupling a large portion of the energy in the near-field of the transmitting antenna 114 to a receiving antenna 118 rather than propagating most of the energy in an electromagnetic wave to a far field. When in this near-field, a coupling mode may be developed between the transmit antenna 114 and the receive antenna 118. The area around the antennas 114 and 118 where this near-field coupling may occur is referred to herein as a coupling-mode region.

In some configurations, where the transmitting entity 104 and receiving entity 108 having similar shaped antennas and matching networks are in very close proximity, the matching networks (not shown) related to the antennas 114, 118 that process the signals may become detuned due to high mutual coupling in signals communicated between the transmitting entity 104 and receiving entity 108, and thus communications between transmitting entity 104 and receiving entity 108 may break down. This condition is referred to herein as over-coupling. In such examples, as described further herein, transmitting entity 104 can include an over-coupling detecting component 350 configured to detect such over-coupling with receiving entity 108 or related receive antenna 118, a transmit (Tx)/receive (Rx) parameter component 352 configured to attempt to mitigate the condition by modifying one or more transmit and/or receive parameters at transmitting entity 104, and/or a filter bypassing component 354 for bypassing filters in the transmitting entity 104 configuration when detecting the over-coupling condition.

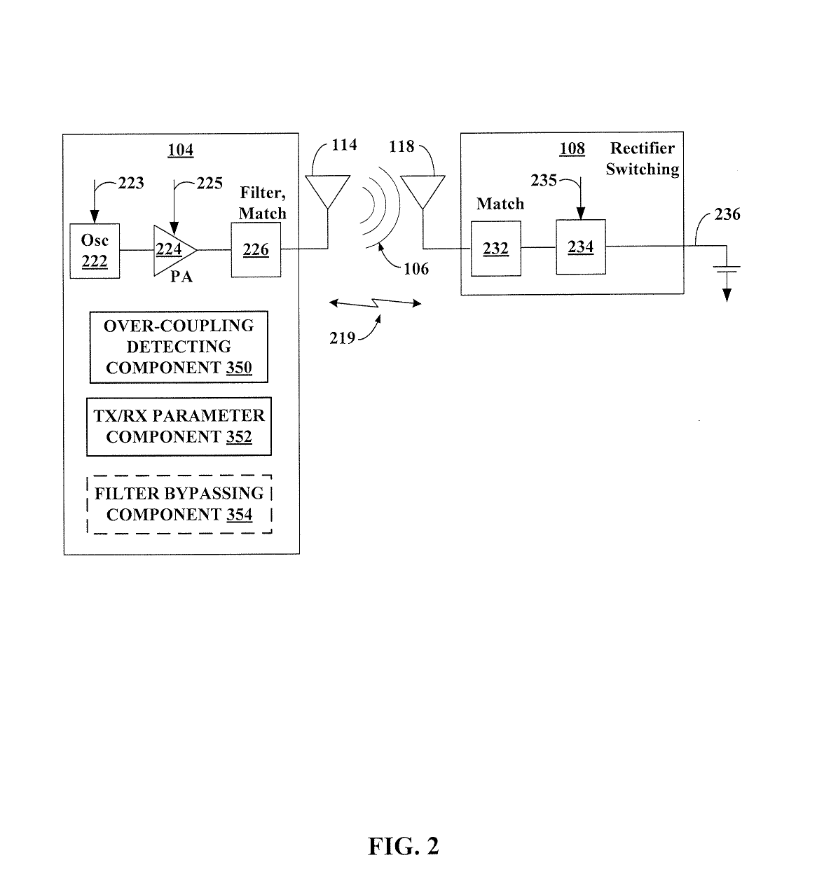

FIG. 2 is a schematic diagram of an example near field wireless communication system. The transmitting entity 104 includes an oscillator 222, a power amplifier 224 and a filter and matching circuit 226 (also referred to herein as a matching network). The oscillator 222 is configured to generate a signal at a desired frequency, which may be adjusted in response to adjustment signal 223. The oscillator signal may be amplified by the power amplifier 224 with an amplification amount responsive to control signal 225. The filter and matching circuit 226 may be included to filter out harmonics or other unwanted frequencies and match the impedance of the transmitting entity 104 to the transmit antenna 114.

The receiving entity 108 may include a matching circuit 232 and a rectifier and switching circuit 234 to generate a DC power output to charge a battery 236 as shown in FIG. 2 or power a device coupled to the receiver (not shown), though it is to be appreciated that devices may each have batteries (e.g., in peer-to-peer communications) such that powering by magnetic field may not be needed. The matching circuit 232 may be included to match the impedance of the receiving entity 108 to the receive antenna 118. The receiving entity 108 and transmitting entity 104 may communicate on a separate communication channel 219 (e.g., Bluetooth, ZigBee, cellular, etc), in one example.

Additionally, for example, transmitting entity 104 can include an over-coupling detecting component 350 for detecting over-coupling between the transmitting entity 104 and receiving entity 108, as described herein, and a Tx/Rx parameter component 352 for modifying one or more transmit or receive parameters at transmitting entity 104 based on detecting the over-coupling. For example, Tx/Rx parameter component 352 modifies one or more parameters that can affect operation of the oscillator 222, power amplifier 224, etc. in transmitting signals, such as an initiator mode resonance, a transmit power, a transmit carrier phase, a transmit power supply voltage, a transmit de-Qing factor, or in receiving signals, such as a receive acquisition threshold, a receiver gain, a receiver local oscillator (LO) phase, etc. Transmitting entity 104 may also include a filter bypassing component 354 for bypassing filters in detecting the over-coupling, as described further herein.

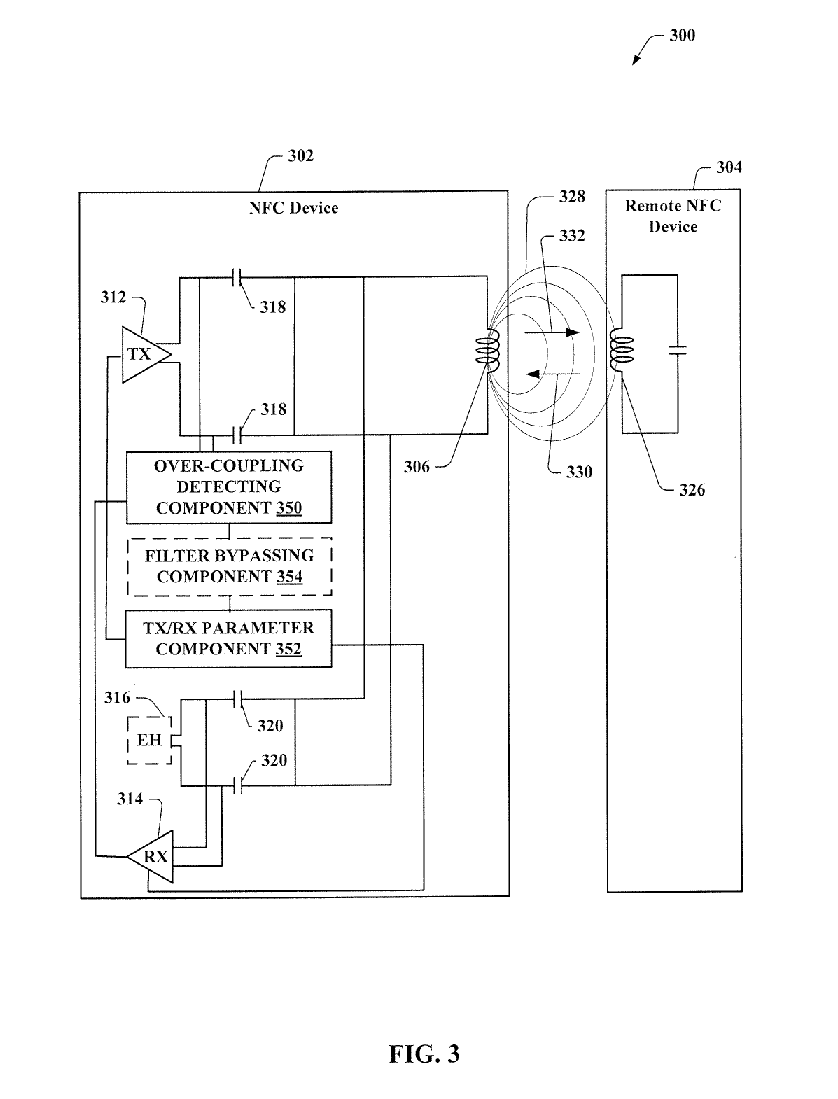

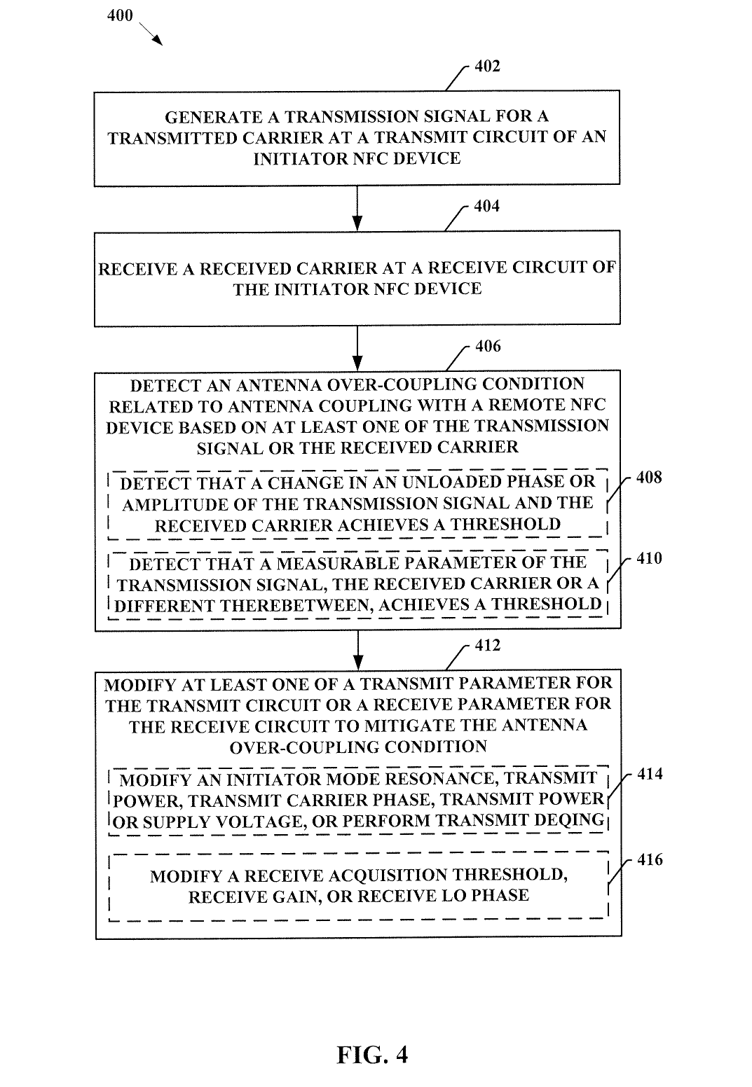

Referring to FIGS. 3 and 4, aspects of the present disclosure are depicted with reference to one or more components and one or more methods that may perform the actions or functions described herein. In an aspect, the term “component” as used herein may be one of the parts that make up a system, may be hardware or software or some combination thereof, and may be divided into other components. Although the operations described below in FIG. 4 are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions.

With reference to FIG. 3, a block diagram of a communication network 300 according to an aspect is illustrated. Communication network 300 may include a NFC device 302, which may be or may include a transmitting entity 104 as described herein, and a remote NFC device 304, which may be or may include a receiving entity 108 as described herein, that may be configured to communicate using NFC. NFC device 302 may include a NFC antenna 306, shown as an antenna coil, configured to facilitate NFC communications with remote NFC device 304, which may have a similar NFC antenna 326.

As part of NFC communications, NFC antenna 306 may generate an electromagnetic field in the area around the NFC antenna 306. The strength of the field may depend on the power source and the size and number of turns in NFC antenna 306 coil. Further, impedance mismatches may cause a range of amplitude changes and/or phase changes dependant on size and inductance of NFC antenna 306 in the magnetic field 328. Capacitor 318 may be connected in parallel with the NFC antenna 306, where a transmitter 312 and capacitors 318 may form an RLC oscillator establishing a resonant circuit with a frequency that corresponds to one or more transmission frequencies of the NFC device 302. Transmitter 312 may also be referred to herein as a transmit circuit. In addition, capacitive elements such as capacitors 318, 320 may form at least part of a matching network for NFC device 302. Because the wavelength of the frequency used is several times greater than the close proximity distance between the NFC antenna 306 and the NFC antenna 326 of the remote NFC device 304, the electromagnetic field can be treated as an alternating magnetic field 328. This region of close proximity is referred to as the near field region. The NFC device 302 and remote NFC device 304 may be linked by their mutual inductance, as in an air core transformer, with the primary coil being the NFC antenna 306 and the secondary coil being the NFC antenna 326 of the remote NFC device 304. The alternating magnetic field 328 radiates into or penetrates the NFC antenna 326 of the remote NFC device 304 when it is in the near field region, inducing an alternating current in the NFC antenna 326 of the remote NFC device 304.

When operating in a listening mode, the NFC antenna 306, capacitors 320, optional energy harvester (EH) 316 and a receiver 314 may form an RLC oscillator establishing a resonant circuit over which modulation of signal by remote NFC device 304 can be detected. Receiver 314 may also be referred to herein as a receive circuit. When operating in a transmitting mode, NFC device 302 may apply a variable load resistance to the NFC antenna 306, thereby modulating magnetic field 328, to send a transmitted signal to transfer data to the remote NFC device 304.

In an aspect, NFC device 302 may also include an over-coupling detecting component 350 for detecting an over-coupling condition between NFC device 302 and remote NFC device 304 related to NFC antenna 306 and/or the NFC antenna 326, respectively (e.g., when the antenna coils are in very close proximity to one another such that they strongly couple). For example, over-coupling detecting component 350 may base a determination of over-coupling condition on a characterization of one or more aspects of an unmodulated received carrier 330 received by receiver 314 based on transmission of a transmission signal 332 by transmitter 312. For example, transmitter 312 can transmit a carrier in initiator mode as transmission signal 332 that is not modulated by remote NFC device 304. In this way, the transmission signal 332 sent by transmitter 312 may be looped-back to receiver 314, and received as unmodulated received carrier 330. Where the NFC device 302 and remote NFC device 304 are within close proximity and have the same or similar antenna configuration (e.g., shape, size, etc.) and/or matching network, unmodulated received carrier 330 can essentially be transmission signal 332 as modified by passing through the coupled NFC antenna 326, which may be attached to matching circuitry, of remote NFC device 304. Over-coupling detecting component 350 can accordingly compare characteristics of the unmodulated received carrier 330 to one or more thresholds and/or to the transmission signal 332 to detect the over-coupling condition. The one or more thresholds can be based on characterization of aspects of the unmodulated received carrier 330 for various conditions (e.g., unloaded, lower coupling, over-coupling, etc.).

Further, NFC device 302 may also include a Tx/Rx parameter component 352 for modifying one or more transmit or receive parameters (e.g., for transmitter 312 and/or receiver 314) based on detecting the over-coupling condition. For instance, Tx/Rx parameter component 352 may modify at least one of an initiator mode resonance, a receive acquisition threshold, a transmit power, a transmit carrier phase, a transmit power supply voltage, a transmit de-Qing factor, a receiver gain, or a receiver local oscillator phase based at least in part on detecting the antenna over-coupling condition. Optionally, in some aspects, NFC device 302 may also include a filter bypassing component 354 for bypassing one or more filters that may be present between receiver 314 (or related NFC antenna 306) and over-coupling detecting component 350 to allow the over-coupling detecting component 350 to detect the over-coupling condition based on signals received at NFC antenna 306 without applying at least some filtering thereto (e.g., initiator mode carriers or other signals from which the over-coupling condition can be determined). It is to be appreciated that in the examples described herein, NFC device 302 and remote NFC device 304 can have NFC antennas 306 and 326 of similar shape (e.g., coil), size, etc., and/or the NFC devices 302 and 304 may utilize the same or similar matching networks, which can cause the over-coupling condition when the NFC devices 302 and 304 are in close proximity. Thus, remote NFC device 304 can have similar NFC-related components as the NFC device 302, though the components are not shown for ease of explanation.

FIG. 4 illustrates an example method 400 for detecting and/or mitigating an antenna over-coupling condition detected among NFC devices. Method 400 includes, at Block 402, generating a transmission signal for a transmitted carrier at a transmit circuit of an initiator NFC device. For example, transmitter 312 (FIG. 3) can generate the transmission signal for the transmitted carrier at a transmitter circuit (which can be or can include the transmitter 312), and can transmit the transmission signal over NFC antenna 306. In one example, transmitter 312 can transmit the signal for the purpose of detecting the over-coupling condition. The signal can include a carrier transmitted by the NFC device 302 when in an initiator mode (e.g., during a guard time when an NFC field is allowed before allowing modulated signals to be sent by the remote NFC device 304, such as an initial 5 milliseconds (ms) of the initiator mode). In another example, the signal can include a carrier transmitted by the NFC device following one or more packet receptions by the NFC device 302 from remote NFC device 304 (e.g., following receiving an indication of end-of-file from the remote NFC device 304).

Method 400 also includes, at Block 404, receiving a received carrier at a receive circuit of the initiator NFC device. For example, receiver 314 can receive the received carrier (and thus may be or may include the receive circuit). For instance, receiver 314 is coupled to transmitter 312, as shown, and can accordingly receive the transmitted carrier from the transmit circuit. Because the transmitter 312 and receiver 314 share the same antenna, there is a common connection among the transmitter 312 and receiver 314 at the antenna. Accordingly, if there are any coupling changes at the antenna due to presence of another NFC device, the over-coupling detecting component 350 can detect this change based on a detected change in one or more measured characteristics of the received carrier as compared to the transmission signal 332. For example, the carrier sent by the transmitter 312 in initiator mode can be received by receiver 314, and may exhibit certain properties described herein where the carrier traversed the antenna and/or matching network of remote NFC device 304.

Thus, method 400 further includes, at Block 406, detecting an antenna over-coupling condition related to antenna coupling with a remote NFC device based on at least one of the transmission signal or the received carrier. Over-coupling detecting component 350 can detect the antenna over-coupling condition related to antenna coupling with a remote NFC device (e.g., the remote NFC device 304) based at least in part on the transmission signal and the received carrier. For example, over-coupling detecting component 350 can be communicatively coupled to receiver 314 for obtaining the transmitted carrier as transmitted and not modulated by another NFC device, which is also referred to herein as the unmodulated received carrier. Over-coupling detecting component 350 can accordingly detect antenna over-coupling based at least in part on comparing aspects of the unmodulated received carrier to the transmission signal generated by the transmitter 312 (e.g., by the LO). For instance, the unmodulated received carrier may have traversed the NFC antenna 326 and/or matching network components of remote NFC device 304 where NFC antenna 326 is within a close proximity of NFC antenna 306. Over-coupling detecting component 350 can detect whether this occurred and resulted in an over-coupling condition based on characterization of aspects of the unmodulated received carrier for various conditions. For example, the conditions can include an unloaded, lower coupling, over-coupling, etc. conditions, and one or more thresholds corresponding to the conditions can be defined in the NFC device 302, as described herein, such that over-coupling detecting component 350 detects the over-coupling or other conditions based at least in part on comparing aspects of the unmodulated received carrier to the one or more thresholds and/or comparing aspects of the unmodulated received carrier as compared with the transmitted signal to the one or more thresholds.

For example, when the NFC devices 302 and 304 are in very close proximity (e.g., within a few centimeters), the presence of the NFC antenna 326 near the NFC antenna 306 and matching network (e.g., capacitors 320, EH 316, etc.) can cause the phase or amplitude of the unmodulated received carrier and of the transmission signal to differ at least by a threshold, which can be indicative of the over-coupling condition. In this condition, NFC antennas 306 and 326 and the matching networks of the NFC devices 302 and 304 become over-coupled, as described, and thus cannot reliably communicate with one another. In this close coupling relationship, the transmitted carrier can traverse the NFC antenna 326 and/or matching network of remote NFC device 304, and this can result in a phase change and/or an amplitude change (e.g., to a different phase or amplitude) in the unmodulated received carrier. Accordingly, detecting the antenna over-coupling condition at Block 406 may include, at Block 408, detecting that a change in an unloaded phase or amplitude of the transmission signal and the received carrier achieves a threshold. Over-coupling detecting component 350 can detect that the change in the unloaded phase or amplitude of the transmission signal and the received carrier achieves the threshold. Over-coupling detecting component 350 may detect this change at least because the transmission carrier and transmission signal (LO signals) are generated from the same source (e.g., transmitter 312).

Over-coupling detecting component 350 can include, or can be used in conjunction with, various detectors to determine other measurable parameters of the transmission signal and the unmodulated received carrier, similar to the phase/amplitude relationship, conditions related thereto, such as an increase in a direct current (DC) or alternating current (AC) signal of the received carrier, and/or other signal characteristics that may be indicative of the over-coupling condition. Thus, in another example, detecting the antenna over-coupling condition at Block 406 can include, at Block 410, detecting that a measurable parameter of the transmission signal, the received carrier, or a difference therebetween, achieves a threshold. Over-coupling detecting component 350 can detect that the measurable parameter of the transmission signal, the received carrier, or the difference therebetween, achieves the threshold. For instance, change in the carrier phase/amplitude during the over-coupling condition can dominate a carrier level reduction in changing an unloaded DC level, so the DC level of the received carrier may increase during the over-coupling condition due to the carrier initial phase with respect to LO(I) and LO(Q) of the transmission signal. Accordingly, the measureable parameter may include the DL level, such that a change in the DC level of I or the DC level of Q that achieves a threshold may indicate the over-coupling condition. Thus, where over-coupling detecting component 350 detects a variation in DC level between the transmission signal and the unmodulated received carrier that achieves a threshold, over-coupling detecting component 350 can detect the over-coupling condition. It is to be appreciated that over-coupling detecting component 350 can detect an antenna unloaded or lower coupling case as well based on comparing a change in the DC level to lower threshold amounts.

In another example, over-coupling detecting component 350 may include a peak detector function (e.g., at the transmitter or receiver port of NFC antenna 306, NFC antenna 306 itself, in the matching network or circuitry, etc.) to output a DC voltage equal to a DC peak of the carrier (e.g., as transmitted by transmitter 312 or received by receiver 314). Accordingly, the measurable parameter may include the DC peak voltage, and where the DC peak voltage of the unmodulated received carrier achieves a threshold (e.g., as defined for an unloaded or lower coupling), over-coupling detecting component 350 can detect the over-coupling condition. In another example, over-coupling detecting component 350 may include an envelope detector function to output an envelope (e.g., a curve indicating extremes in amplitude) of the unmodulated received carrier. Accordingly, the measurable parameter may include the envelope of the unmodulated received carrier, and where the envelope indicates an amplitude extreme achieves a threshold (e.g., as defined for an unloaded or lower coupling), over-coupling detecting component 350 can detect the over-coupling condition. In yet another example, energy harvester 316 can store energy received from the unmodulated received carrier, and thus over-coupling detecting component 350 can utilize the EH 316 to determine a level of energy of the unmodulated received carrier stored at the EH 316. Accordingly, the measurable parameter may include the level of energy of the unmodulated received carrier, and where level of energy achieves a threshold amount (e.g., as defined for an unloaded or lower coupling), over-coupling detecting component 350 can detect the over-coupling condition. In any case, it is to be appreciated that the thresholds can be configured in the NFC device 302, and may be based on a received configuration, hardcoded values, etc., and/or may be obtained from simulations or observed degradation in communication quality between NFC device 302 and multiple NFC devices, etc.

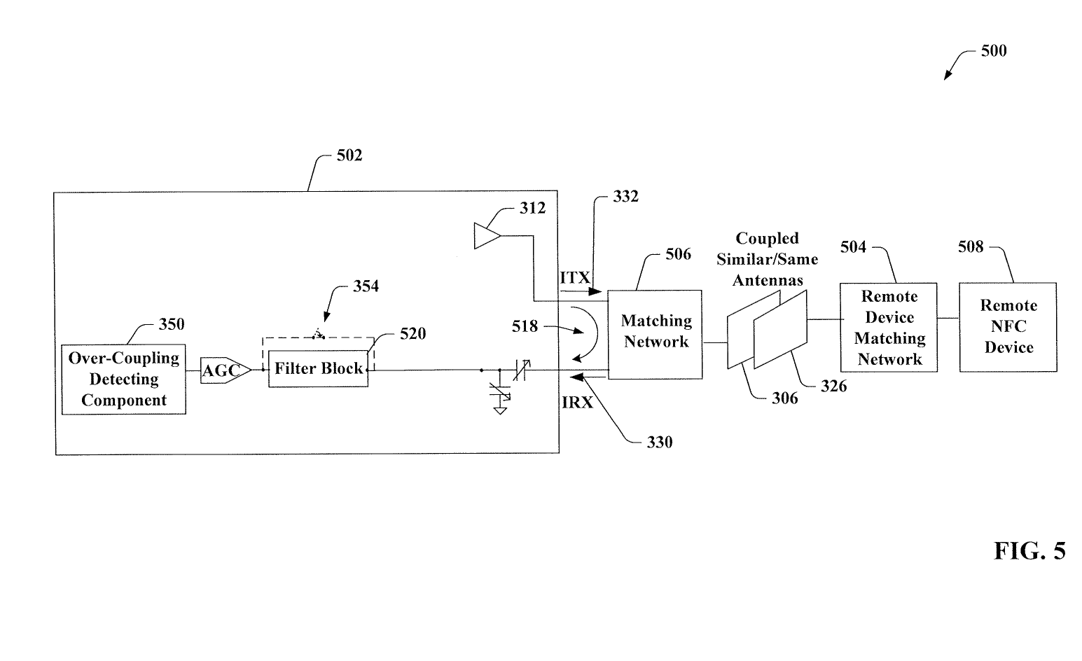

In another example described in further detail in FIG. 5, over-coupling detecting component 350 may include a DC estimation block for estimating the DC voltage of the unmodulated received carrier (e.g., DC In-phase (I) or DC Quadrature (Q)), which are compared to that of the transmission signal to detect the over-coupling condition. In this example, and/or the examples described above where components of the NFC device 302 are reused for the purpose of detecting the over-coupling condition, a filter bypassing component 354 can also be used to bypass any filters or other components in the matching network that are normally applied to the received carrier. This allows the over-coupling detecting component 350 to detect the over-coupling condition using the unmodulated carrier as received before any filtering or other processing is applied.

Method 400 also includes, at Block 412, modifying at least one of a transmit parameter for the transmit circuit or a receive parameter for the receive circuit to mitigate the antenna over-coupling condition. For example, Tx/Rx parameter component 352 can modify at least one of a transmit parameter for the transmitter 312 or a receive parameter for the receiver 314 to mitigate the antenna over-coupling condition. It is to be appreciated that the Tx/Rx parameter component 352 can modify the transmit or receive parameter for a duration while the over-coupling condition is detected so as not to impact NFC communications occurring outside of the condition.

Modifying a transmit parameter for the transmit circuit at block 412 may include, at Block 414, modifying an initiator mode resonance, transmit power, transmit carrier phase, or transmit power supply voltage, or perform transmit deQing. For example, Tx/Rx parameter component 352 may increase an initiator mode resonance based on detecting the over-coupling condition. In a specific example, Tx/Rx parameter component 352 may increase an initiator mode resonance of transmitter 312 from a first resonance (e.g., 13.56 megahertz (MHz)) to a higher resonance (e.g., ˜14.7 MHz) when over-coupling is detected. For example, because over-coupling causes the resonance to shift to a lower frequency, utilizing a higher uncoupled initiator resonance can result in shifting to a more desired resonant frequency where front end losses are minimized (e.g., at or near 13.56 MHz) when in the over-coupling condition. It is to be appreciated, however, that lower resonances can be utilized in this regard as well. In other examples, Tx/Rx parameter component 352 can increase transmit power of the transmitter 312, optimize the transmit carrier phase, increase transmit power supply voltage, perform transmit deQing to reduce/increase a quality factor. Modifying such parameters can be based on configured incrementing/decrementing (e.g., stepping) values, based on the level at which the phase/amplitude and/or measurable parameters of the transmission signal, received carrier, or the difference therebetween exceeds the corresponding threshold, etc.

In an additional or alternative example, modifying the at least one receive parameter for the receive circuit at Block 412 may include, at Block 414, modifying a receive acquisition threshold, a receive gain, or a receive LO phase. For example, Tx/Rx parameter component 352 may modify the receive acquisition threshold, the receive gain, or the receive LO phase. For instance, Tx/Rx parameter component 352 may increase signal threshold for acquiring signals from the remote NFC device 304 at a greater probability. In one example, the one or more receive parameters can relate to a receive acquisition threshold or other modem parameters for acquiring signals from the remote NFC device 304 at a greater probability, which can be modified based on a detected over-coupling condition. In one specific example, Tx/Rx parameter component 352 may increase the receive acquisition threshold based on a detected increase or decrease in the DC level (e.g., based on the phase or amplitude change in the received carrier) to allow for receiving signals of greater power when in the over-coupling condition. In other examples, Tx/Rx parameter component 352 can adjust a receive gain at receiver 314, optimize a receive LO phase (e.g., at the I or Q branch), etc. when the over-coupling condition is detected to improve communications with the remote NFC device 304 during the condition. Modifying such parameters can be based on configured incrementing/decrementing (e.g., stepping) values, based on the level at which the phase/amplitude and/or measurable parameters of the transmission signal, received carrier, or the difference therebetween exceeds the corresponding threshold, etc.

As described, since adjusting the Tx/Rx parameters can impact performance of the NFC device outside of the over-coupling condition, Tx/Rx parameter component 352 can modify the Tx/Rx parameters when the over-coupling detecting component 350 detects the over-coupling condition (e.g., before each transmission or after packet reception), and may utilize previous values for the Tx/Rx parameters when over-coupling has ceased or is otherwise no longer detected.

Referring to FIG. 5, a block diagram of a communication network 500 is illustrated. Communication network 500 includes an NFC device 502, which may be an initiator NFC device (e.g., NFC device 302 in FIG. 3), and a remote NFC device 504 (e.g., remote NFC device 304 in FIG. 3), which may include similar components as NFC device 502 (e.g., excluded from this figure for ease of explanation). In addition, NFC devices 502 and 504 can include similar matching networks 506 and 508 and/or similar NFC antennas 306 and 326, respectively, which become coupled when within close proximity, as described above. It is to be appreciated that matching networks 506 and 508 may include one or more capacitive elements such as capacitors and may have a same or similar configuration. In this specific example of an NFC device, over-coupling detecting component 350 can be a DC estimation block of NFC device 502 used to detect the over-coupling condition between NFC devices 502 and 504. As shown, the initiator transmit chain (ITX) is looped to the initiator receive chain (IRX) at 518 to facilitate obtaining the unmodulated received carrier 330 corresponding to the transmission signal 332 (e.g., from NFC antenna 306), as described, which may have characteristics that change (relative to an unloaded condition) based on the load from the coupled NFC antenna 326 and/or matching network 508 of remote NFC device 504. In an aspect, the unmodulated carrier can be provided to the over-coupling detecting component 350 by additionally bypassing one or more filters in a filter block 520 using filter bypassing component 354, which includes a switch in this figure. Although illustrated as entirely bypassing filter block 520, it should be noted that filter bypassing component 354 may only bypass a subset of filters within filter block 520.

As described, the DC component level may depend on the carrier amplitude and/or phase. Thus, the DC component level of the received carrier as measured by over-coupling detecting component 350 can indicate a change in amplitude or phase of the received carrier as compared to the transmission signal generated by transmitter 312. A change in the DC component level, e.g., relative to an unloaded condition, that achieves a threshold may be indicative of the over-coupling condition since the received carrier and LO signals are generated from the same source (transmitter 312). When the over-coupling condition is detected, as described, Tx/Rx parameters (e.g. of the transmitter 312 or related receiver in the IRX chain) can be modified to optimize IRX for reception. For example, in initiator mode, firmware can run the over-coupling condition detection and mitigation, as described herein, at initiator guard time (e.g., an initial 5 ms of unmodulated carrier), after IRX end-of-file at the end of every packet received, etc.

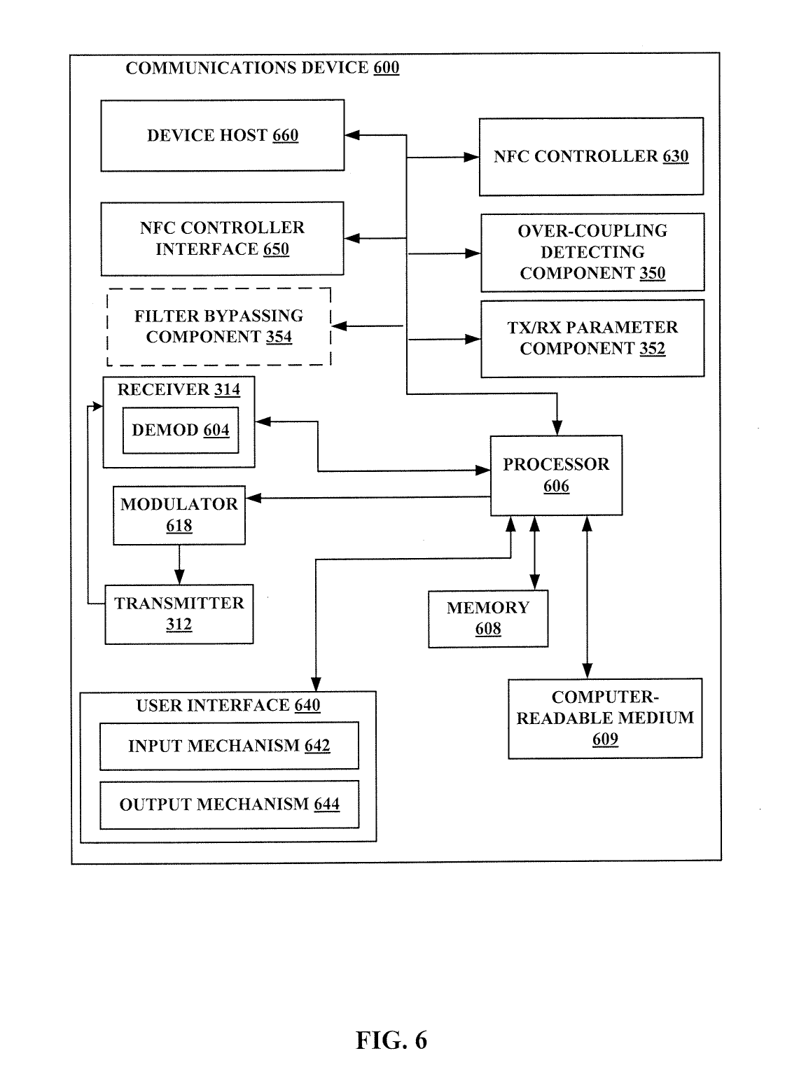

FIG. 6 illustrates an example architecture of communications device 600. Communications device may 600 include NFC device 302, 502, remote NFC device 304, 504, etc., and may thus include components thereof and/or perform the associated functions described above. As depicted in FIG. 6, communications device 600 includes receiver 314 that receives a signal from, for instance, a receive antenna (not shown), performs typical actions on (e.g., filters, amplifies, downconverts, etc.) the received signal, and digitizes the conditioned signal to obtain samples. Receiver 314 can include a demodulator 604 that can demodulate received symbols and provide them to processor 606 for channel estimation. Processor 606 can be a processor dedicated to analyzing information received by receiver 314 and/or generating information for transmission by transmitter 312, a processor that controls one or more components of communications device 600, and/or a processor that both analyzes information received by receiver 314, generates information for transmission by transmitter 312, and controls one or more components of communications device 600. Further, signals may be prepared for transmission by transmitter 312 through modulator 618 which may modulate the signals processed by processor 606.

Communications device 600 can additionally include memory 608 that is operatively coupled to processor 606 and that can store data to be transmitted, received data, information related to available channels, transmission control protocol (TCP) flows, data associated with analyzed signal and/or interference strength, information related to an assigned channel, power, rate, or the like, and any other suitable information for estimating a channel and communicating via the channel.

Further, transmitter 312 can generate a transmission signal for a transmitted carrier at a transmit circuit, and receiver 314 can receive an unmodulated received carrier at a receive circuit. As described, transmitter 312 can be looped back to receiver 314 so the receiver 314 can receive the unmodulated carrier. Processor 606 can include or can implement over-coupling detecting component 350 for detecting an over-coupling condition with another communications device based on comparing the received unmodulated carrier to the transmission signal generated by transmitter 312. As described, where the over-coupling condition occurs, this can be detected based on a determining that a difference between a phase, amplitude, DC level, or other metric of the received carrier and transmission signal achieves a threshold and/or other conditions described herein. When the over-coupling condition is detected, Processor 606 can include or can implement Tx/Rx parameter component 352 for modifying a transmit or receive parameter of transmitter 312 or receiver 314, as described, to mitigate the over-coupling condition. Processor 606 may also include or implement filter bypassing component 354 for bypassing one or more filters or other signal processing components of communications device 600 that may exist between the receiver 314 and over-coupling detecting component 350 to facilitate detection of over-coupling in the signal unaltered by the components.

It will be appreciated that data store (e.g., memory 608) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 608 of the subject systems and methods may comprise, without being limited to, these and any other suitable types of memory. For example, memory 608 can include instructions for performing the functions of the various components described herein. Processor 606 may also be coupled to a computer-readable medium 609, which may be or may include memory 608, or other computer-readable or storage mediums described herein, which can include instructions or code for executing the various components of communications device 600.

Communications device 600 may include NFC controller interface (NCI) 650. In an aspect, NCI 650 may be configured to enable communications between a NFC controller 630 and device host 660.

Additionally, communications device 600 may include user interface 640. User interface 640 may include input mechanisms 642 for generating inputs into communications device 600, and output mechanism 644 for generating information for consumption by the user of the communications device 600. For example, input mechanism 642 may include a mechanism such as a key or keyboard, a mouse, a touch-screen display, a microphone, etc. Further, for example, output mechanism 644 may include a display, an audio speaker, a haptic feedback mechanism, etc. In the illustrated aspects, the output mechanism 644 may include a display configured to present media content that is in image or video format or an audio speaker to present media content that is in an audio format.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer-readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, mobile equipment (ME), remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used in communication devices that are utilized for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH, near-field communications (NFC-A, NFC-B, NFC,-f, etc.), and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules configured to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An example storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer-readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or aspects, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

What is claimed is:

1. A method of mitigating an antenna over-coupling condition in a near field communication (NFC) device, comprising:
generating a transmission signal for a transmitted carrier at a transmit circuit of an initiator NFC device;
receiving a received carrier at a receive circuit of the initiator NFC device;
detecting, at the initiator NFC device, the antenna over-coupling condition related to antenna coupling with a remote NFC device based on at least one of the transmission signal or the received carrier; and
modifying at least one of a transmit circuit parameter for the transmit circuit or a receive circuit parameter for the receive circuit to mitigate the antenna over-coupling condition.

2. The method of claim 1, wherein detecting the antenna over-coupling condition comprises determining that a direct current (DC) level between the transmission signal and the received carrier differ at least by a threshold.

3. The method of claim 2, wherein determining the DC level between the transmission signal and the received carrier differ comprises detecting that at least a DC In-phase (I) level or a DC Quadrature (Q) level differ at least by the threshold.

4. The method of claim 1, wherein detecting the antenna over-coupling condition comprises determining a phase change between the transmission signal and the received carrier differ at least by a threshold.

5. The method of claim 1, wherein detecting the antenna over-coupling condition comprises determining an amplitude change between the transmission signal and the received carrier differ at least by a threshold.

6. The method of claim 1, wherein detecting the antenna over-coupling condition comprises determining a direct current (DC) peak of the received carrier achieves a threshold.

7. The method of claim 1, wherein detecting the antenna over-coupling condition comprises determining an envelope of the received carrier achieves a threshold.

8. The method of claim 1, wherein detecting the antenna over-coupling condition comprises determining an energy from the received carrier achieves a threshold.

9. The method of claim 1, wherein modifying at least one of the transmit circuit parameter or the receive circuit parameter comprises increasing an initiator mode resonance based at least in part on detecting the antenna over-coupling condition.

10. The method of claim 1, wherein modifying at least one of the transmit circuit parameter or the receive circuit parameter comprises modifying a receive acquisition threshold for establishing communications with other NFC devices.

11. The method of claim 1, wherein modifying at least one of the transmit circuit parameter or the receive circuit parameter comprises modifying at least one of a transmit power, a transmit carrier phase, a transmit power supply voltage, a transmit de-Qing factor, a receiver gain, or a receiver local oscillator phase.

12. An apparatus for mitigating an antenna over-coupling condition in a near field communication (NFC) device, comprising:
a transmitter configured to generate a transmission signal for a transmitted carrier at a transmit circuit of an initiator NFC device;
a receiver configured to receive a received carrier at a receive circuit of the initiator NFC device;
an over-coupling detecting component configured to detect, at the initiator NFC device, the antenna over-coupling condition related to antenna coupling with a remote NFC device based on at least one of the transmission signal or the received carrier; and
a transmit (Tx)/receive (Rx) parameter component configured to modify at least one of a transmit circuit parameter for the transmit circuit or a receive circuit parameter for the receive circuit to mitigate the antenna over-coupling condition.

13. The apparatus of claim 12, wherein the over-coupling detecting component is configured to detect the antenna over-coupling condition at least in part by determining that a direct current (DC) level between the transmission signal and the received carrier differ at least by a threshold.

14. The apparatus of claim 12, wherein the over-coupling detecting component is configured to detect the antenna over-coupling condition at least in part by determining a phase change between the transmission signal and the received carrier differ at least by a threshold.

15. The apparatus of claim 12, wherein the over-coupling detecting component is configured to detect the antenna over-coupling condition at least in part by determining an amplitude change between the transmission signal and the received carrier differ at least by a threshold.

16. The apparatus of claim 12, wherein the over-coupling detecting component is configured to detect the antenna over-coupling condition at least in part by at least one of determining a direct current (DC) peak of the received carrier achieves a first threshold, determining an envelope of the received carrier achieves a second threshold, or determining an energy from the received carrier achieves a third threshold.

17. The apparatus of claim 12, wherein the Tx/Rx parameter component is configured to modify at least one of the transmit circuit parameter or the receive circuit parameter at least in part by increasing an initiator mode resonance based at least in part on detecting the antenna over-coupling condition.

18. The apparatus of claim 12, wherein the Tx/Rx parameter component is configured to modify at least one of the transmit circuit parameter or the receive circuit parameter at least in part by modifying a receive acquisition threshold for establishing communications with other NFC devices.

19. The apparatus of claim 12, wherein the Tx/Rx parameter component is configured to modify at least one of the transmit circuit parameter or the receive circuit parameter at least in part by modifying at least one of a transmit power, a transmit carrier phase, a transmit power supply voltage, a transmit de-Qing factor, a receiver gain, or a receiver local oscillator phase.

20. An apparatus for mitigating an antenna over-coupling condition in a near field communication (NFC) device, comprising:
means for generating a transmission signal for a transmitted carrier at a transmit circuit of an initiator NFC device;
means for receiving a received carrier at a receive circuit of the initiator NFC device;
means for detecting, at the initiator NFC device, the antenna over-coupling condition related to antenna coupling with a remote NFC device based on at least one of the transmission signal or the received carrier; and
means for modifying at least one of a transmit circuit parameter for the transmit circuit or a receive circuit parameter for the receive circuit to mitigate the antenna over-coupling condition.

21. The apparatus of claim 20, wherein the means for detecting detects the antenna over-coupling condition at least in part by determining that a direct current (DC) level between the transmission signal and the received carrier differ at least by a threshold.

22. The apparatus of claim 20, wherein the means for detecting detects the antenna over-coupling condition at least in part by determining a phase change between the transmission signal and the received carrier differ at least by a threshold.

23. The apparatus of claim 20, wherein the means for detecting detects the antenna over-coupling condition at least in part by determining an amplitude change between the transmission signal and the received carrier differ at least by a threshold.

24. The apparatus of claim 20, wherein the means for detecting detects the antenna over-coupling condition at least in part by at least one of determining a direct current (DC) peak of the received carrier achieves a first threshold, determining an envelope of the received carrier achieves a second threshold, or determining an energy from the received carrier achieves a third threshold.

25. The apparatus of claim 20, wherein the means for modifying modifies at least one of the transmit circuit parameter or the receive circuit parameter at least in part by increasing an initiator mode resonance based at least in part on detecting the antenna over-coupling condition, modifying a receive acquisition threshold for establishing communications with other NFC devices, or modifying at least one of a transmit power, a transmit carrier phase, a transmit power supply voltage, a transmit de-Qing factor, a receiver gain, or a receiver local oscillator phase.

26. A computer-readable medium storing computer executable code for mitigating an antenna over-coupling condition in a near field communication (NFC) device, comprising:
code for generating a transmission signal for a transmitted carrier at a transmit circuit of an initiator NFC device;
code for receiving a received carrier at a receive circuit of the initiator NFC device;
code for detecting, at the initiator NFC device, the antenna over-coupling condition related to antenna coupling with a remote NFC device based on at least one of the transmission signal or the received carrier; and
code for modifying at least one of a transmit circuit parameter for the transmit circuit or a receive circuit parameter for the receive circuit to mitigate the antenna over-coupling condition.

27. The computer-readable medium of claim 26, wherein the code for detecting detects the antenna over-coupling condition at least in part by determining that a direct current (DC) level between the transmission signal and the received carrier differ at least by a threshold.

28. The computer-readable medium of claim 26, wherein the code for detecting detects the antenna over-coupling condition at least in part by determining a phase change between the transmission signal and the received carrier differ at least by a threshold.

29. The computer-readable medium of claim 26, wherein the code for detecting detects the antenna over-coupling condition at least in part by at least one of determining an amplitude change between the transmission signal and the received carrier differ at least by a first threshold, determining a direct current (DC) peak of the received carrier achieves a second threshold, determining an envelope of the received carrier achieves a third threshold, or determining an energy from the received carrier achieves a fourth threshold.

30. The computer-readable medium of claim 26, wherein the code for modifying modifies at least one of the transmit circuit parameter or the receive circuit parameter at least in part by increasing an initiator mode resonance based at least in part on detecting the antenna over-coupling condition, modifying a receive acquisition threshold for establishing communications with other NFC devices, or modifying at least one of a transmit power, a transmit carrier phase, a transmit power supply voltage, a transmit de-Qing factor, a receiver gain, or a receiver local oscillator phase.
